(19) United States
(12) Patent Application Publication
(10) Pub. No.: US 2011/0184841 A1
(43) Pub. Date: Jul. 28, 2011

(54) TRANSACTION BASED LICENSING SYSTEM

(75) Inventors: Ajay Sood, Bangalore (IN); ViJay K. Sukthankar, Bangalore (IN)

(73) Assignee: INTERNATIONAL BUSINESS MACHINES CORPORATION, Armonk, NY (US)

(21) Appl. No.: 12/692,750

(22) Filed: Jan. 25, 2010

(51) Int. Cl. G06Q 30/00; G06Q 50/00; G06Q 20/00; G06Q 10/00

(52) U.S. Cl. 705/34; 705/30

(57) ABSTRACT

Disclosed is a method for transaction based licensing. The method comprises generating an entry in a transaction database at the start of a transaction issued by an application. On completion of the transaction, the entry in the transaction database is completed. Finally, a licensing charge is computed based on one or more completed entries in the transaction database.

### BACKGROUND

The invention relates to distributed transaction service level agreements (SLAs), and more particularly to assessing licensing charges in SLAs based upon completed transactions.

Under Service Level Agreements (SLAs), users pay license fees depending on how much system resource, such a processor cycles or memory, the licensed software was utilizing. Typical License Metrics Tools are developed to calculate resource utilization in Processor Value Units (PVUs). PVUs based on the activity of the actual processor are not always an accurate measure of resource utilization by software running on a virtual machine. A licensing manager needs to be able to distinguish between virtual and actual processor cycles to monitor compliance with a PVU based license.

### SUMMARY

According to a first aspect of the present disclosure, there is provided a method for transaction based licensing. The method comprises generating an entry in a transaction database at the start of a transaction issued by an application. On completion of the transaction, the entry in the transaction database is completed. Finally, a licensing charge is computed based on one or more completed entries in the transaction database.

According to a second aspect of the present disclosure, there is provided a system for transaction based licensing. The system comprises a transaction agent running on a local computer system. The transaction agent is adapted to generate an entry in a transaction database at the start of a transaction issued by an application, and complete the entry in the transaction database on completion of the transaction. The system further comprises a monitoring agent running on a remote computer system adapted to communicate with the local computer system over a network. The monitoring agent is adapted to compute a licensing charge based on one or more completed entries in the transaction database.

According to another aspect of the present disclosure, there is provided a computer program product including a computer readable medium having recorded thereon a computer program for implementing any one of the methods described above.

### BRIEF DESCRIPTION OF THE DRAWINGS

One or more embodiments of the present invention will now be described with reference to the drawings, in which:

FIG. 1 is an illustration of a virtualized machine;

FIG. 2 is an illustration of a cloud computing system;

FIG. 3 illustrates a system for transaction based software licensing according to one embodiment;

FIGS. 4A and 4B form a schematic block diagram of a general purpose computer system as which the computer systems of FIG. 3 may be implemented; and

FIG. 5 is a flow chart illustrating the operation and interaction of the processes in the system of FIG. 3 in more detail.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. The computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

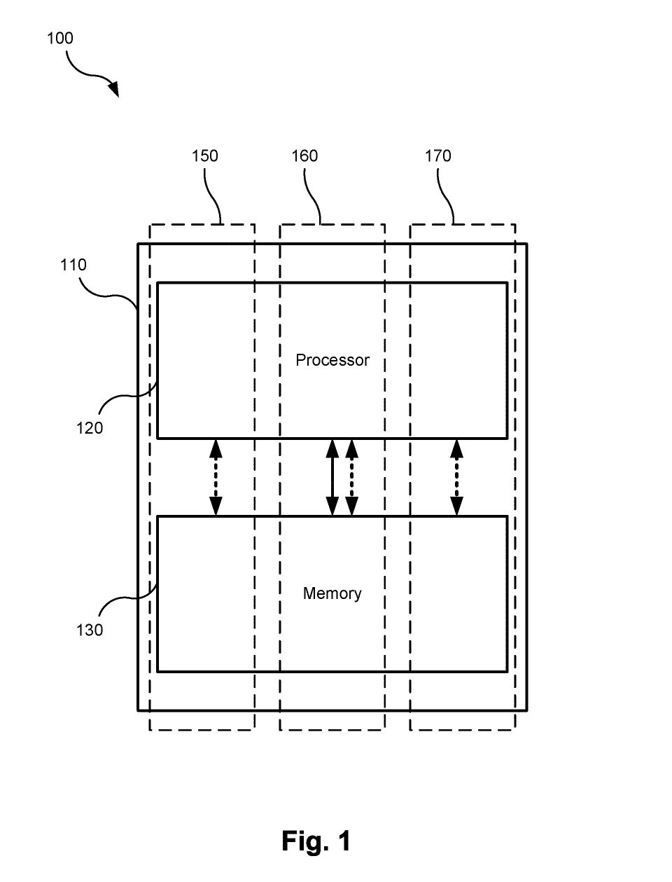

Virtualized Machines and Cloud Computing are technologies that are a challenge to PVU based charging. Virtualized Machine technology is illustrated by the system 100 in FIG. 1. System hardware resources, e.g. the processor 120 and the memory 130 of the computer 110, are partitioned into multiple “Virtual Machines”, e.g. 150, 160, and 170, each with a “virtual processor” and virtual memory, capable of running software independently of the other virtual processors and memories.

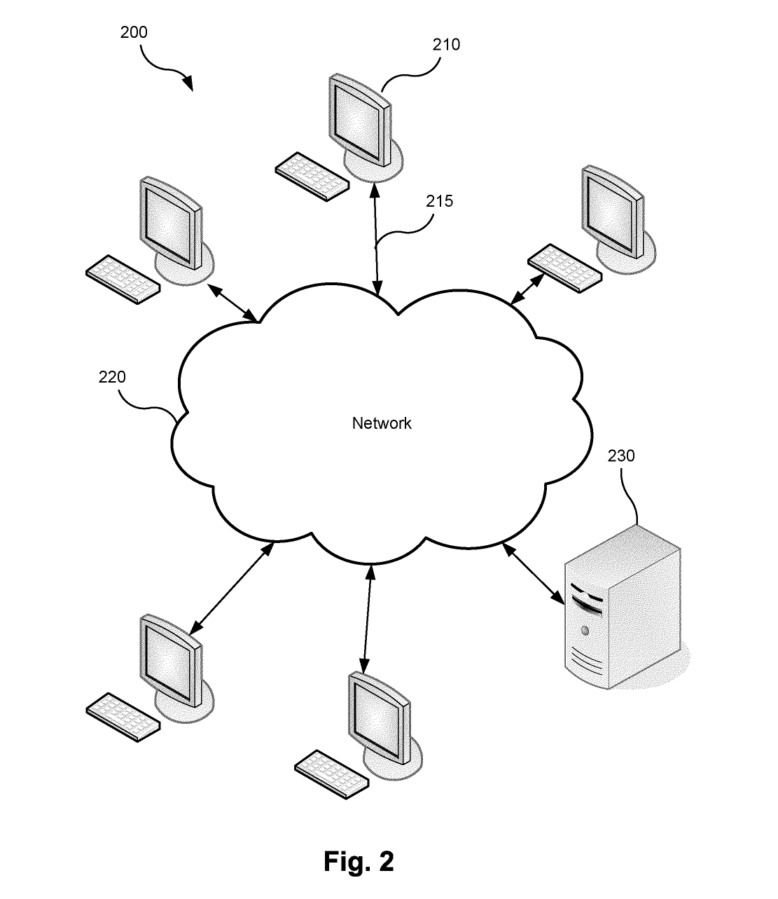

Cloud computing environments often require additional steps, as illustrated by the system 200 in FIG. 2. The system 200 allows multiple users, each with a local machine, e.g. 210, to run software utilizing shared remote computing resources, e.g. at a server 230, accessed via a connection 215 to a network 220, such as the Internet. Since the software utilizes the shared remote resources as well as the local machine's resources, PVUs based on the activity of the local machine's processor are not always an accurate measure of resource utilization for licensing purposes

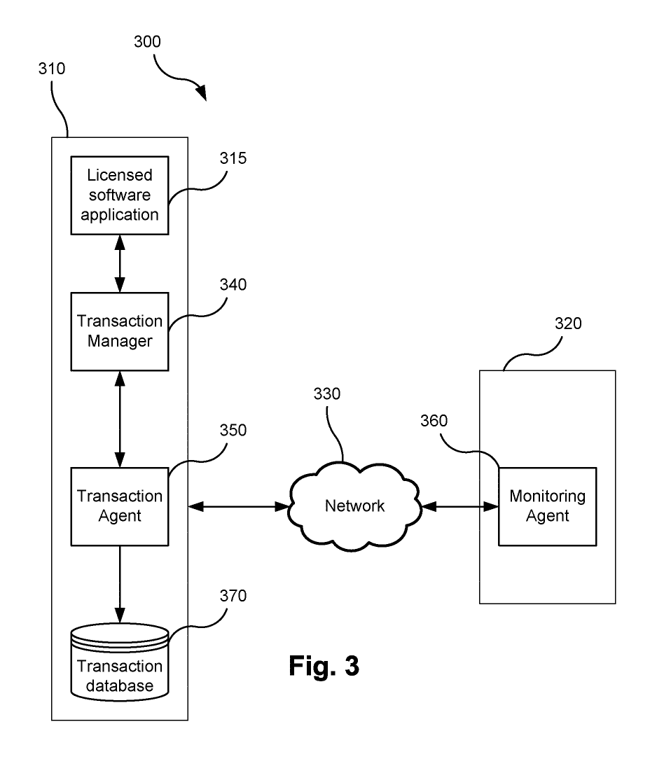

FIG. 3 illustrates a system 300 for transaction based licensing according to one embodiment of the invention. The system 300 of FIG. 3 is referred to as a transaction based license monitoring system because transactions are monitored for license compliance rather than PVUs. In the system 300, a local computer system 310 is running a software application 315 that is the subject of a transaction based license that is being monitored by the system 300. The software application 315 issues transactions. The local computer system 310 runs two further processes related to license monitoring: a transaction manager 340, and a transaction agent 350. The local computer system 310 also comprises a transaction database 370 that is maintained by the transaction agent 350.

The local computer system 310 communicates with a remote computer system 320 over a network 330. The remote computer system 320 runs a process 360 called a monitoring agent. In a cloud computing environment, the transactions may be issued over the network 330. The transaction manager 340 interacts with the transaction agent 350 and the monitoring agent 360 in the manner described below to record completed transactions and monitor compliance with the transaction based license.

The system 300 can comprise multiple local machines 310, each running instances of the licensed software application 315. Each local machine 310 also runs an instance of the transaction manager 340 and the transaction agent 350 and communicates with the monitoring agent 360 running on the remote machine 320. If the local machines 310 are all at the same enterprise, the system 300 is capable of monitoring an “enterprise wide” license for the licensed application 315.

Alternatively, in a virtualized environment, there could be multiple virtual machines, each representing a partition of the resources of the local machine 310 and capable of running independent instances of the licensed software application 315. In this alternative, the local machine 310 would need to run only one instance of the transaction manager 340 and the transaction agent 350 to monitor license compliance.

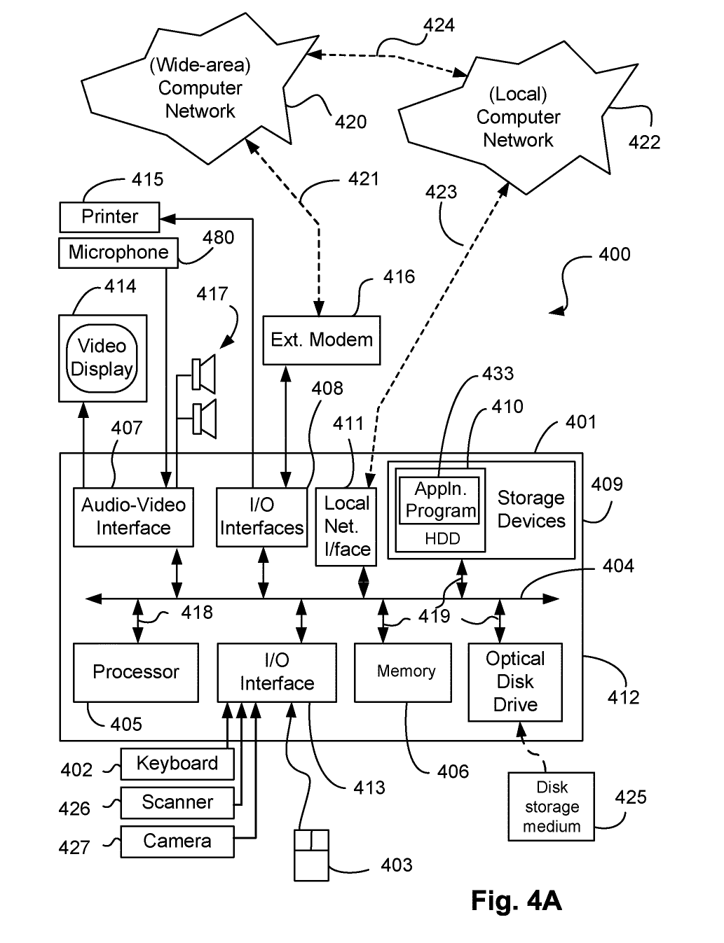

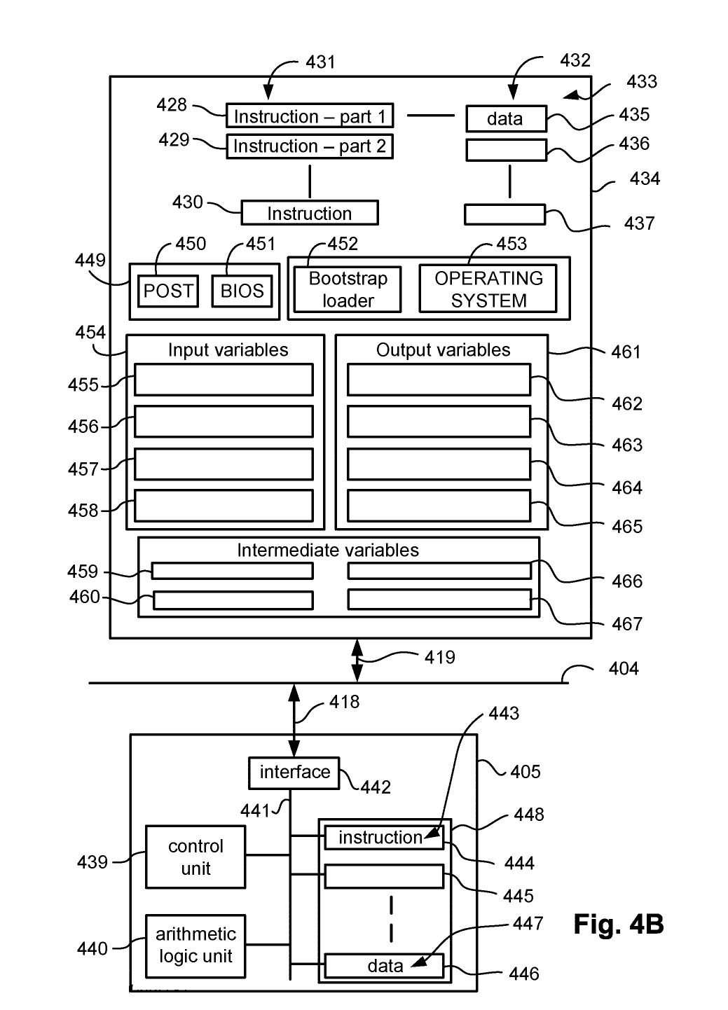

FIGS. 4A and 4B collectively form a schematic block diagram of a general purpose computer system 400, as which the computer systems 310 and 320 of FIG. 3 can be implemented. As seen in FIG. 4A, the computer system 400 is formed by a computer module 401, input devices such as a keyboard 402, a mouse pointer device 403, a scanner 426, a camera 427, and a microphone 480, and output devices including a printer 415, a display device 414 and loudspeakers 417. An external Modulator-Demodulator (Modem) transceiver device 416 may be used by the computer module 401 for communicating to and from a communications network 420 via a connection 421. The network 420, which may be identified with the network 330 of FIG. 3, may be a wide area network (WAN), such as the Internet or a private WAN. Where the connection 421 is a telephone line, the modem 416 may be a traditional “dial-up” modem. Alternatively, where the connection 421 is a high capacity (eg: cable) connection, the modem 416 may be a broadband modem. A wireless modem may also be used for wireless connection to the network 420.

The computer module 401 typically includes at least one processor unit 405, and a memory unit 406 for example formed from semiconductor random access memory (RAM) and semiconductor read only memory (ROM). The module 401 also includes an number of input/output (I/O) interfaces including an audio-video interface 407 that couples to the video display 414, loudspeakers 417 and microphone 480, an I/O interface 413 for the keyboard 402, mouse 403, scanner 426, camera 427 and optionally a joystick (not illustrated), and an interface 408 for the external modem 416 and printer 415. In some implementations, the modem 416 may be incorporated within the computer module 401, for example within the interface 408. The computer module 401 also has a local network interface 411 which, via a connection 423, permits coupling of the computer system 400 to a local computer network 422, known as a Local Area Network (LAN). As also illustrated, the local network 422 may also couple to the wide network 420 via a connection 424, which would typically include a so called “firewall” device or device of similar functionality. The interface 411 may be formed by an Ethernet™ circuit card, a Bluetooth™ wireless arrangement or an IEEE 802.11 wireless arrangement.

The interfaces 408 and 413 may afford either or both of serial and parallel connectivity, the former typically being implemented according to the Universal Serial Bus (USB) standards and having corresponding USB connectors (not illustrated). Storage devices 409 are provided and typically include a hard disk drive (HDD) 410. Other storage devices such as a floppy disk drive and a magnetic tape drive (not illustrated) may also be used. An optical disk drive 412 is typically provided to act as a non-volatile source of data. Portable memory devices, such optical disks (eg: CD-ROM, DVD), USB-RAM, and floppy disks for example may then be used as appropriate sources of data to the system 400.

The components 405 to 413 of the computer module 401 typically communicate via an interconnected bus 404 and in a manner which results in a conventional mode of operation of the computer system 400 known to those in the relevant art.

The processes of FIG. 3, to be described below, may be implemented as software 433 executable within the computer system 400. In particular, the steps of the processes of FIG. 3 are effected by instructions 431 in the software 433 that are carried out within the computer system 400. The software instructions 431 may be formed as one or more code modules, each for performing one or more particular tasks. The software may also be divided into two separate parts, in which a first part and the corresponding code modules performs the processes of FIG. 3 and a second part and the corresponding code modules manage a user interface between the first part and the user.

The software 433 is generally loaded into the computer system 400 from a computer readable storage medium, and is then typically stored in the HDD 410, as illustrated in FIG. 4A, or the memory 406, after which the software 433 can be executed by the computer system 400. In some instances, the application programs 433 may be supplied to the user encoded on one or more CD-ROM 425 and read via the corresponding drive 412 prior to storage in the memory 410 or 406. Alternatively the software 433 may be read by the computer system 400 from the networks 420 or 422 or loaded into the computer system 400 from other computer readable media. Computer readable storage media refers to any storage medium that participates in providing instructions and/or data to the computer system 400 for execution and/or processing. Examples of such storage media include floppy disks, magnetic tape, CD-ROM, a hard disk drive, a ROM or integrated circuit, USB memory, a magneto-optical disk, or a computer readable card such as a PCMCIA card and the like, whether or not such devices are internal or external of the computer module 401. Examples of computer readable transmission media that may also participate in the provision of software, application programs, instructions and/or data to the computer module 401 include radio or infra-red transmission channels as well as a network connection to another computer or networked device, and the Internet or Intranets including e-mail transmissions and information recorded on Websites and the like.

The second part of the application programs 433 and the corresponding code modules mentioned above may be executed to implement one or more graphical user interfaces (GUIs) to be rendered or otherwise represented upon the display 414. Through manipulation of typically the keyboard 402 and the mouse 403, a user of the computer system 400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 417 and user voice commands input via the microphone 480.

FIG. 4B is a detailed schematic block diagram of the processor 405 and a “memory” 434. The memory 434 represents a logical aggregation of all the memory devices (including the HDD 410 and semiconductor memory 406) that can be accessed by the computer module 401 in FIG. 4A.

When the computer module 401 is initially powered up, a power on self-test (POST) program 450 executes. The POST program 450 is typically stored in a ROM 449 of the semiconductor memory 406. A program permanently stored in a hardware device such as the ROM 449 is sometimes referred to as firmware. The POST program 450 examines hardware within the computer module 401 to ensure proper functioning, and typically checks the processor 405, the memory (409, 406), and a basic input-output systems software (BIOS) module 451, also typically stored in the ROM 449, for correct operation. Once the POST program 450 has run successfully, the BIOS 451 activates the hard disk drive 410. Activation of the hard disk drive 410 causes a bootstrap loader program 452 that is resident on the hard disk drive 410 to execute via the processor 405. This loads an operating system 453 into the RAM memory 406 upon which the operating system 453 commences operation. The operating system 453 is a system level application, executable by the processor 405, to fulfill various high level functions, including processor management, memory management, device management, storage management, software application interface, and generic user interface.

The operating system 453 manages the memory (409, 406) in order to ensure that each process or application running on the computer module 401 has sufficient memory in which to execute without colliding with memory allocated to another process. Furthermore, the different types of memory available in the system 400 must be used properly so that each process can run effectively. Accordingly, the aggregated memory 434 is not intended to illustrate how particular segments of memory are allocated (unless otherwise stated), but rather to provide a general view of the memory accessible by the computer system 400 and how such is used.

The processor 405 includes a number of functional modules including a control unit 439, an arithmetic logic unit (ALU) 440, and a local or internal memory 448, sometimes called a cache memory. The cache memory 448 typically includes a number of storage registers 444-446 in a register section. One or more internal buses 441 functionally interconnect these functional modules. The processor 405 typically also has one or more interfaces 442 for communicating with external devices via the system bus 404, using a connection 418.

The application program 433 includes a sequence of instructions 431 that may include conditional branch and loop instructions. The program 433 may also include data 432 which is used in execution of the program 433. The instructions 431 and the data 432 are stored in memory locations 428-430 and 435-437 respectively. Depending upon the relative size of the instructions 431 and the memory locations 428-430, a particular instruction may be stored in a single memory location as depicted by the instruction shown in the memory location 430. Alternately, an instruction may be segmented into a number of parts each of which is stored in a separate memory location, as depicted by the instruction segments shown in the memory locations 428-429.

In general, the processor 405 is given a set of instructions which are executed therein. The processor 405 then waits for a subsequent input, to which it reacts to by executing another set of instructions. Each input may be provided from one or more of a number of sources, including data generated by one or more of the input devices 402, 403, data received from an external source across one of the networks 420, 422, data retrieved from one of the storage devices 406, 409 or data retrieved from a storage medium 425 inserted into the corresponding reader 412. The execution of a set of the instructions may in some cases result in output of data. Execution may also involve storing data or variables to the memory 434.

The processes of FIG. 3 use input variables 454, that are stored in the memory 434 in corresponding memory locations 455-458. The processes of FIG. 3 produce output variables 461, that are stored in the memory 434 in corresponding memory locations 462-465. Intermediate variables may be stored in memory locations 459, 460, 466 and 467.

The register section 444-446, the arithmetic logic unit (ALU) 440, and the control unit 439 of the processor 405 work together to perform sequences of micro-operations needed to perform “fetch, decode, and execute” cycles for every instruction in the instruction set making up the program 433. Each fetch, decode, and execute cycle comprises:

(a) a fetch operation, which fetches or reads an instruction 431 from a memory location 428;

(b) a decode operation in which the control unit 439 determines which instruction has been fetched; and

(c) an execute operation in which the control unit 439 and/or the ALU 440 execute the instruction.

Thereafter, a further fetch, decode, and execute cycle for the next instruction may be executed. Similarly, a store cycle may be performed by which the control unit 439 stores or writes a value to a memory location 432.

Each step or sub-process in the processes of FIG. 3 is associated with one or more segments of the program 433, and is performed by the register section 444-447, the ALU 440, and the control unit 439 in the processor 405 working together to perform the fetch, decode, and execute cycles for every instruction in the instruction set for the noted segments of the program 433.

The processes of FIG. 3 may alternatively be implemented in dedicated hardware such as one or more integrated circuits performing the functions or sub functions of the processes of FIG. 3. Such dedicated hardware may include graphic processors, digital signal processors, or one or more microprocessors and associated memories.

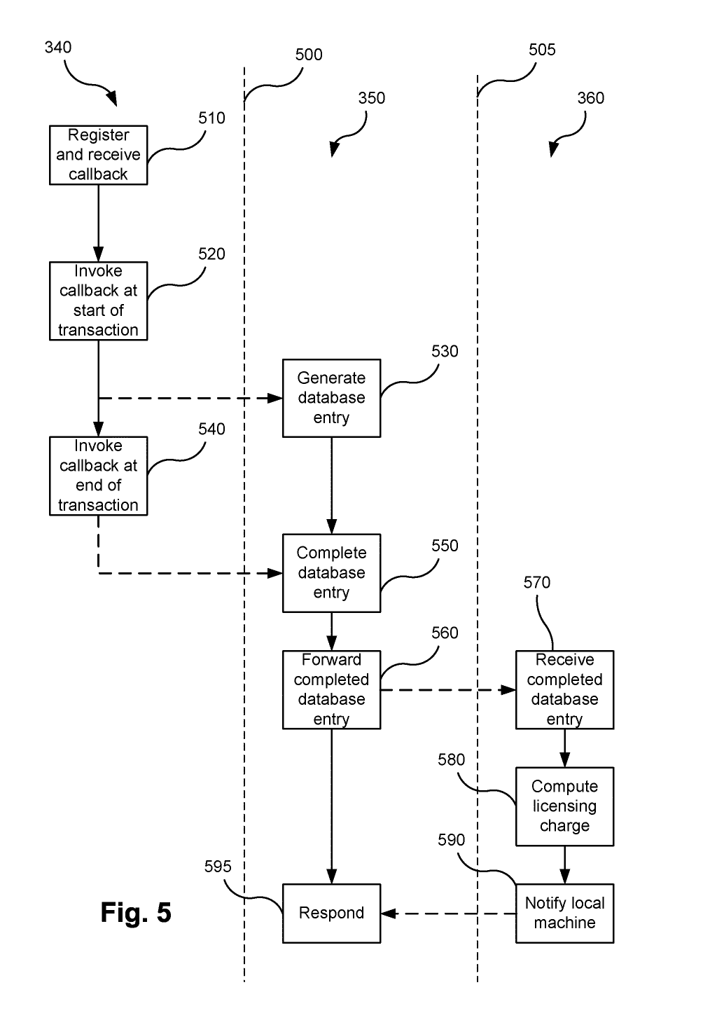

FIG. 5 is a flow chart illustrating the operation and interaction of the processes 340, 350, and 360 in the system 300 of FIG. 3 in more detail. The steps on the left of the vertical line 500 form part of the transaction manager 340, while those between vertical line 500 and the vertical line 505 form part of the transaction agent 350, and those on the right of the vertical line 505 form part of the monitoring agent 360. The transaction manager 340 begins at step 510 by registering with the transaction agent 350, at which the point transaction manager 340 receives a callback. Step 510 is carried out only once, while the remaining steps 520 to 560 are carried out each time a distributed transaction is issued by the software application 315. A distributed transaction is a transaction involving the coordination of multiple resources. At the step 520, the transaction manager 340 invokes the callback at the start of the transaction, which causes the transaction agent 350 (step 530) to generate an entry in the transaction database 370 corresponding to the issued transaction. The generated entry comprises the following fields:

Transaction identifier

Coordinator identifier—this field identifies the originator of the transaction

Started (Boolean)

Ended (Boolean)

Time Started

Time Ended

Service identifier

Participant identifier(s)

At step 530, the Ended field is “false” and the Time Ended field is empty. After the second phase of the transaction, indicating successful completion of the transaction, the transaction manager 340 again invokes the callback (step 540), which causes the transaction agent 350 (step 550) to complete the database entry generated at step 530 by setting Ended to “true” and filling Time Ended with the completion time. At the step 560, the transaction agent 350 forwards the completed database entry to the monitoring agent 360. If the transaction is not completed, for example if a predetermined timeout has elapsed, the transaction agent 350 deletes the generated database entry from the transaction database 370 without forwarding it to the monitoring agent 360. Thus uncompleted transactions do not affect the license monitoring or charging.

The communication from the transaction agent 350 to the monitoring agent 360 is made through an assured delivery protocol such as MQ. In an alternative implementation, the monitoring agent 360 periodically polls the transaction agent 350 to retrieve the completed entries in the transaction database 370.

The monitoring agent 360 has details of the transaction-based Service Level Agreement (SLA) relating to the licensed software application 315. The SLA could be based on various metrics, some examples being:

Average transactions per second over a predetermined time interval

Peak transactions per second over a predetermined time interval

Total number of transactions in a predetermined time interval.

The monitoring agent 360 receives (step 570) the completed distributed transactions from the transaction agent 350. In step 580, the monitoring agent 360 computes appropriate license charges based on one or more received completed transactions. The computation in step 580 depends on the nature of the SLA. In one implementation, which is suitable for the third metric mentioned above, the monitoring agent 360 computes the licensing charge LM_{X} based on the number of completed transactions over the predetermined interval, for example by multiplying the number of completed transactions by a unit cost per transaction. The monitoring agent 360 compares the computed licensing charge with the scheduled payment amount LM_{Y} for the predetermined interval. If LM_{X} exceeds LM_{Y}, the monitoring agent 360 notifies the transaction agent 350 (step 590) that the license SLA has been violated. The notification in step 590 optionally comprises the amount by which the licensing charge LM_{X} exceeds the scheduled payment amount LM_{Y}. The transaction agent 350 responds (step 595) to the notification, for example by disallowing further execution of the licensed software application 315, or notifying the user of the licensed software application 315 of the excess amount.

In an alternative implementation, the computation of the licensing charge at step 580 is dependent on the type of transaction completed. Transactions could be database transactions, application server transactions, transactions from a content manager, or transactions from some other middleware product or some other product. This implementation allows combined licensing for multiple software applications under a single umbrella, assuming each application issues transactions of the designated types. In one implementation, the transaction agent 350 records the type of each completed transaction in a “type” field of the generated database entry. Alternatively, the monitoring agent 360 looks up a table mapping the coordinator identifier of the transaction to a transaction type. Denoting N transaction types as TR₁ to TR_{N}, each type having a corresponding predetermined transaction cost Cₙ, the monitoring agent 360 computes the licensing charge LM_{X} as follows:

$${LM}_{X} = {\sum }_{n = 1}^{N} {C}_{n} {X}_{n}$$

where Xₙ is the number of completed transactions of type TRₙ.

Additional charge points can be implemented using the above arrangements. For example, the licensing charge computation in step 580 could be dependent on the participants in each transaction, or services used in the transaction, each of which are fields in the completed database entry.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts, or combinations of special purpose hardware and computer instructions.

The foregoing describes only some embodiments of the present invention, and modifications and/or changes can be made thereto without departing from the scope and spirit of the invention, the embodiments being illustrative and not restrictive.

We claim:

1. A method for transaction based licensing, the method comprising:
generating a record at the start of a distributed transaction issued by an application;
assessing a license charge to an account based on one or more completed entries for the number of distributed transactions;
comparing the licensing charge with a scheduled payment amount; and
prohibiting further execution of the application when the license charge exceeds the scheduled amount.

2. The method of claim 1, further comprising deleting the record if the transaction is not completed.

3. The method of claim 1, further comprising completing the entry on completion of the transaction

4. The method of claim 1, wherein the record comprises structured or unstructured data storage.

4. The method of claim 1, wherein assessing a license charge further comprises a limiting the charge to a predetermined time interval.

5. The method of claim 1, wherein the assessing a license charge comprises multiplying the number of completed entries by a unit cost per transaction.

6. The method of claim 1, wherein generating an entry in a transaction database includes a plurality of n-transactions, and the assessing a license charge comprises multiplying a number completed n-transactions by a unit cost per n-transaction, and summing the products of n-transactions and costs per n-transactions.

7. A system for transaction based licensing, the system comprising:
a transaction agent running on a local computer system, the transaction agent being adapted to:
generate an entry in a transaction database at the start of a transaction issued by an application; and
complete the entry in the transaction database on completion of the transaction; and
a monitoring agent running on a remote computer system adapted to communicate with the local computer system over a network, the monitoring agent being adapted to assessing a license charge to an account based on one or more completed entries for the number of distributed transactions based upon completed entries in the transaction database;
comparing the computed licensing charge with a scheduled payment amount; and
disallowing further execution of the application when the license charge exceeds the scheduled amount.

8. A computer program product having a computer readable storage medium having a computer program recorded thereon for transaction based licensing, said computer program product comprising:
computer program code for generating an entry in a transaction database at the start of a transaction issued by an application;
computer program code for completing the entry in the transaction database on completion of the transaction; and
computer program code for assessing a license charge to an account based on one or more completed entries for the number of distributed transactions based upon completed entries in the transaction database;
computer program code for comparing the computed licensing charge with a scheduled payment amount; and
computer program code for disallowing further execution of the application when the license charge exceeds the scheduled amount.
